(19) United States
(12) Patent Application Publication
(10) Pub. No.: US 2025/0192638 A1
(43) Pub. Date: Jun. 12, 2025

(54) SYSTEM FOR TRANSMITTING A DRIVING TORQUE

(71) Applicant: NTN EUROPE, Annecy (FR)

(72) Inventor: Vincent POURROY-SOLARI, Annecy (FR)

(21) Appl. No.: 18/845,437

(22) PCT Filed: Mar. 9, 2023
(86) PCT No.: PCT/EP2023/056056

§ 371 Date: Sep. 10, 2024

(30) Foreign Application Priority Data
Mar. 10, 2022 (FR) FR2202115

(51) Int. Cl. H02K 5/173; F16C 19/08; H02K 7/08; H02K 7/116

(52) U.S. Cl. CPC H02K 5/1732; F16C 19/08; H02K 7/083; H02K 7/116; F16C 2380/26

(57) ABSTRACT

The invention relates to a system for transmitting a driving torque comprising a rotor (1) driven in rotation with respect to a stator (2) housed in a casing (3) via a rear bearing (4) and a front bearing (5), each of said bearings having an internal member (4i, 5i) mounted on the rotor (1) and an external member (4e, 5e) secured to the casing (3), said rotor having a torque transmission mechanism (6) which is arranged at the front of the front bearing (5), the members (5i, 5e) of the front bearing (5) each having two runway tracks forming two raceways in which a respective row of spherical rolling bodies (14) is arranged, the rows of rolling bodies (14) being in angular contact in the raceways in an X arrangement.

The invention relates to system for transmitting a driving torque comprising a rotor driven in rotation with respect to a stator housed in a casing.

The invention relates in particular to an electrical machine of the motor and/or generator type in which the casing casing incorporates means for electromagnetic coupling with the rotor so as to transform electrical energy into mechanical energy transmitted by said rotor and/or such mechanical energy into electrical energy.

It applies in particular to such machines for the propulsion of a motor vehicle with an electric motor, in which the rotor comprises a mechanism for transmitting a driving torque to the wheels, said mechanism also making it possible to transmit a driving torque from said wheels to generate an electric current for recharging a battery.

Conventionally, the rotor is rotatably mounted in the casing by means of a rear bearing and a front bearing which are axially spaced between said rotor and said casing, each of said bearings having an internal member mounted on the rotor and an external member secured to the casing.

In addition to guiding the rotor in rotation, the bearings must hold the rotor axially and radially in the casing, so as to ensure optimum transmission of the torque and reliable cooperation between the rotor and the stator.

To meet these constraints, we know of the use of bearings whose members each have a runway track forming a raceway between said members, in which a row of spherical rolling bodies are arranged in radial contact in said raceway to enable rotation of the internal member relative to the external member about the rotor axis.

This type of bearing has a radial clearance between the members which is necessary to absorb the dimensional variations of its mounting at the interface between the rotor and the casing, said clearance also making it possible to reduce the drag torque of the bearing and therefore the energy dissipated by its rotation.

However, osculation of this type of bearing induces an axial clearance between the members, which runs counter to the axial stability of the rotor when transmitting a driving torque.

In particular, as the front bearing is located on the side of the torque transmission mechanism, it is subject to high mechanical stresses, particularly axial stresses, which can lead to significant displacements, particularly axial displacements, of the rotor in the casing.

Such axial forces could be absorbed by increasing the contact angles of the rolling bodies in the raceway. However, this solution requires an increase in the radial clearance between the members, which is detrimental to the efficiency of the transmission system.

The aim of the invention is to improve the prior art by proposing, in particular, a system for transmitting a driving torque in which the bearings provide an optimum compromise between their functions of guiding and holding the rotor in the casing, particularly with regard to the axial stability of the rotor and the limitation of the drag torque induced by the rotation of the bearings.

To this end, the invention proposes a system for transmitting a driving torque comprising a rotor driven in rotation with respect to a stator housed in a casing, said rotor being mounted for rotation in the casing by means of a rear bearing and a front bearing which are axially spaced between said rotor and said casing, each of said bearings having an internal member mounted on the rotor and an external member secured to the casing, said rotor having a torque transmission mechanism which is arranged at the front of the front bearing, the members of the front bearing each having two runway tracks which are axially spaced so as to form between said members two raceways in which a row of spherical rolling bodies is respectively arranged to enable rotation of the internal member relative to the external member about the rotor axis, the rows of rolling bodies being in angular contact in the raceways in an X arrangement.

Further objects and advantages of the invention will become apparent from the following description, made with reference to the appended figures, in which:

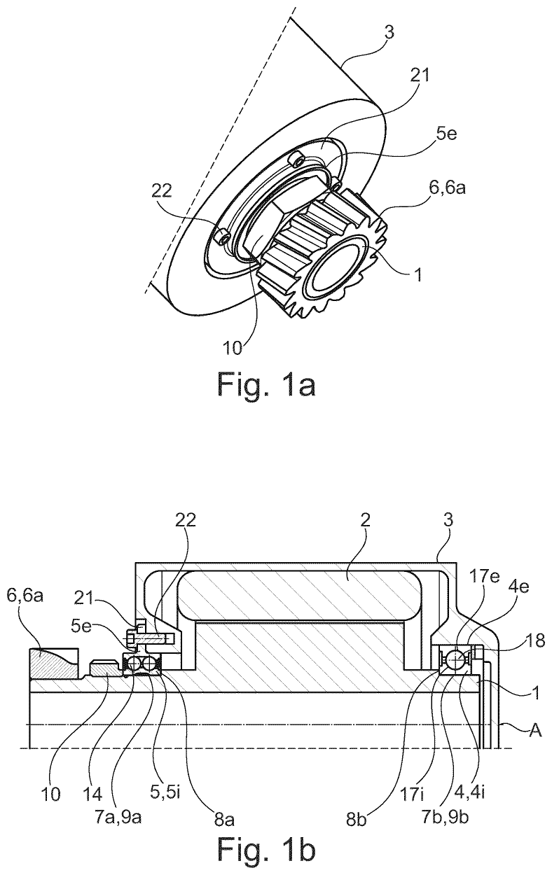

FIGS. 1a, 1b and 1c show a transmission system according to an embodiment of the invention, respectively partially in perspective (FIG. 1a), in longitudinal half-section (FIG. 1b) and in enlarged view of FIG. 1b (FIG. 1c);

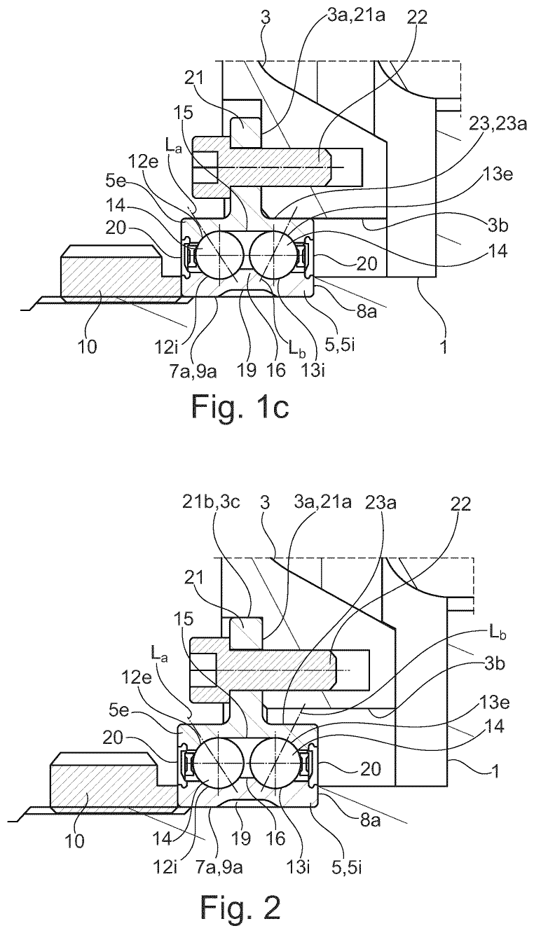

FIG. 2 is a view analogous to FIG. 1c showing a variant;

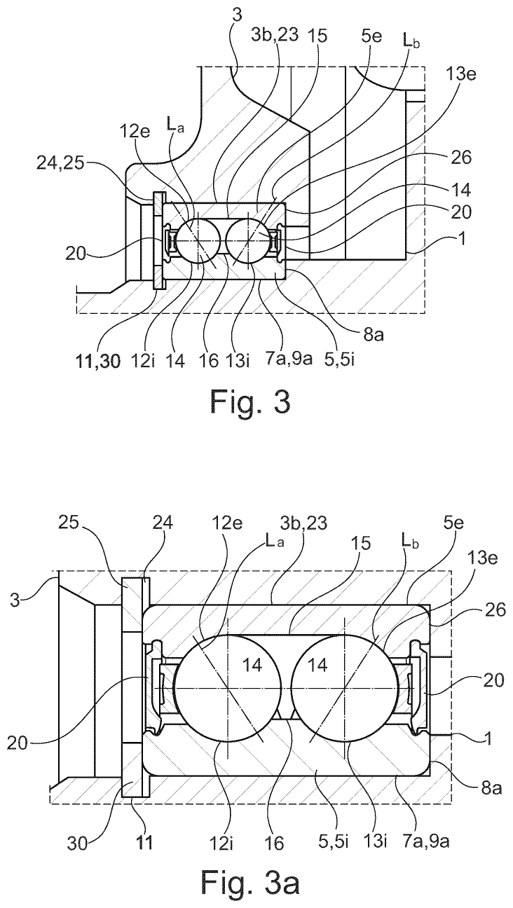

FIG. 3 is a view analogous to FIG. 1c showing another embodiment of the invention, FIG. 3a being an enlargement of FIG. 3.

In relation with these figures, a system for transmitting a driving torque is described below, for example in the form of an electric machine of the motor and/or generator type, which can be used to propel an electrically powered motor vehicle.

The transmission system comprises a rotor 1 driven in rotation about an axis A with respect to a stator 2 housed in a casing 3 incorporating means for electromagnetically coupling with said rotor so as to transform electrical energy into mechanical energy transmitted by said rotor and/or such mechanical energy into electrical energy.

The rotor 1 is rotatably mounted in the casing 3 by means of a rear bearing 4 and a front bearing 5, which are axially spaced between said rotor and said casing, in particular by each being arranged in an interface formed between a rear—respectively front—wall of the casing 3 and a rear—respectively front—portion of the rotor 1.

In the description, the terms “front” and “rear” are defined in relation to the direction of use of the system for location respectively on the left and on the right, particularly in FIG. 1b. The terms “external” and “internal” are defined in relation to the axis A of rotation of the rotor 1, respectively for a location remote from and close to said axis.

The rotor 1 has a torque transmission mechanism 6 which is arranged at the front of the front bearing 5. Referring to FIG. 1a, the torque transmission mechanism 6 comprises at least one gear 6a which is mounted around the rotor 1 at the front of the front bearing 5.

In particular, the gear 6a can be of the helical type to mesh with a complementary gear of the driven element, the cooperation of said gears inducing variations in force, notably axial, on the rotor 1 during transmission of the driving torque.

Each of the bearings 4, 5 has an internal member 4i, 5i mounted on the rotor 1 and an external member 4e, 5e secured to the casing 3. In particular, the internal members 4i, 5i each have a bore, the rotor 1 having a front bearing surface 7a-respectively a rear bearing surface 7b-onto which a complementary bearing surface 9a, 9b of said bore is radially shrunk.

In the figures, the bearing surfaces 7a, 7b extend axially and have a shoulder 8a, 8b on which the internal member 4i, 5i comes into axial abutment at the end of shrinking.

In the embodiment shown in FIGS. 1 and 2, the system comprises a nut 10 mounted at the front of the front bearing 5, said nut being tightened on the front internal member 5i to retain it axially on the front bearing surface 7a, in particular in axial abutment on the shoulder 8a. In particular, the nut 10 is interposed between the front bearing 5 and the transmission mechanism 6.

In FIG. 3, the front bearing surface 7a is bordered by a front groove 11 in which a ring 30 is arranged, said ring being in axial interference with the front internal member 5i to retain it axially on the front bearing surface 7a.

The members 5i, 5e of the front bearing 5 each have two runway tracks 12i, 13i, 12e, 13e which are axially spaced so as to form between said members two raceways in which a respective row of rolling bodies 14 is arranged to enable rotation of the internal member 5i relative to the external member 5e about the axis A of the rotor 1.

In particular, the rolling bodies 14 are spherical, as this configuration has a lower torque than an axial force take-up solution with conical rolling bodies.

In particular, the raceways have substantially the same diameter, with the same number of rolling bodies 14 being provided for each row, in particular by holding said rolling bodies in their row by means of a retaining cage.

The rows of rolling bodies 14 are in angular contact in the raceways in an X arrangement, i.e. the load lines La, Lb connecting the contact surfaces between the rolling bodies 14 of a row and the tracks 12i, 13i; 12e, 13e intersect in an X pattern. In particular, an X arrangement is distinguished from an O arrangement, as for example presented in the Wikipedia page providing a general overview of the technical field of mechanical bearings: https://fr.wikipedia.org/wiki/Roulement_m%C3%A9canique#Roulement_%C3%A0_rouleaux_coniques.

These two rows of rolling bodies 14 enable fine adjustment of the axial and radial clearance between members 5i, 5e, particularly in the front bearing (5), which is subject to the greatest mechanical stress, as the X arrangement limits the possibility of relative axial displacement of said members.

In relation to the figures, the external member 5e of the front bearing 5 is formed from a single piece on which the two runway tracks 12e, 13e are formed, said runway tracks being connected by a central zone 15 formed on the piece. In particular, the central zone 15 extends axially between the runway tracks 12e, 13e.

The internal member 5i of the front bearing 5 is formed from a single piece on which the two runway tracks 12i, 13i are formed, said runway tracks being separated by a collar 16 formed as a radial projection on the piece.

Advantageously, the members 4i, 4e of the rear bearing 4 each have a runway track 17i, 17e forming between said members a raceway in which a row of rolling bodies 18 is arranged to enable rotation of the internal member 4i relative to the external member 4e about the axis A of the rotor 1.

In particular, the rolling bodies 18 of the rear bearing 4 can be spherical by being mounted in radial contact in the raceway, as the osculation of such a bearing can be increased without impacting the axial clearance.

In one embodiment, an axial preload spring washer can be used on the external member 4e to induce a contact angle due to the presence of a radial clearance in the rear bearing 4.

Advantageously, the use of an X arrangement in the front bearing 5 makes it possible to create a complementary bearing surface 9a with a central recess 19 forming on either side a shrunk-on section on the front bearing surface 7a of the rotor 1.

In this way, the impact of the radial stress of the shrink fit on the diameter of the raceways can be reduced, thus limiting the load and therefore the drag torque of the front bearing 5.

Likewise, the use of an X arrangement makes it possible to envisage a front bearing 5 equipped with at least one sealing device comprising an element 20 which is fixed to the external member 5e to rub against the internal member 5i and/or the rotor 1.

In particular, this embodiment reduces the friction diameter of the sealing element 20, and thus limits the drag torque of the front bearing 5.

In relation to FIG. 3a, each side of the front bearing 5 is equipped with an element 20 having one end fixed in a groove bordering a runway track 12e, 13e of the external member 5e, and a free lip rubbing in a groove bordering the runway track 12i, 13i of the internal member 5i. Alternatively, the lip can be positioned close to the internal member 5i to form a chicane.

In particular, the sealing elements 20 limit the leakage of lubricant present in the raceways, as well as the contamination of said raceways with external pollutants.

According to an embodiment shown in FIGS. 1 and 2, the front external member 5e has a flange 21 extending radially outwards from said member, said flange being associated with the casing 3.

In particular, this embodiment makes it possible to limit variations in the diameter of the bottom of the runway track 12e, 13e, which can be induced by a thermal gradient between the casing 3 and the external member 5e, which could increase the drag torque of the front bearing 5 and/or limit the axial strength of the rotor 1.

In the embodiment shown, the flange 21 has a rear face 21a which bears axially against a front wall 3a of the casing 3, said flange and said casing being equipped with means for clamping said face to said wall, notably in the form of screws 22 passing through said flange for fixing in said front wall.

In this way, the radial stiffness of the front external member 5e is increased, which limits the impact on the bottom diameter of the tracks 12e, 13e of its shrink fit in the casing 3, and therefore the drag torque of the front bearing 5 and/or the axial strength of the rotor 1.

Referring to FIGS. 1a to 1c, the casing 3 has a front bearing surface 3b onto which the front external member 5e is radially shrunk by means of a complementary bearing surface 23. In particular, the flange 21 extends around the front external member 5e, delimiting a rear complementary bearing surface 23a which is radially shrunk into the front bearing surface 3b, while bringing the bearing surface 21a of the flange 21 into axial abutment on the front wall 3a of the casing 3.

Alternatively, as shown in FIG. 2, the rear complementary bearing surface 23a is arranged at a radial distance from the front bearing surface 3b, the front bearing 5 being centered by means of a flange 21 having a peripheral bearing surface 21b which is radially shrunk onto a complementary bearing surface 3c of the casing 3, while bringing the bearing surface 21a of the flange 21 into axial abutment on the front wall 3a of the casing 3.

As shown in FIG. 3, the front bearing surface 3b is bordered by a front groove 24 in which a ring 25 is arranged, said ring being in axial interference with the front external member 5e to retain it axially on the front bearing surface 3b. In addition, the front bearing surface 3b is bordered by a rear shoulder 26 on which the external member 5e is in axial abutment.

1. Torque transmission system comprising a rotor (1) driven in rotation with respect to a stator (2) housed in a casing (3), said rotor being rotatably mounted in the casing (3) by means of a rear bearing (4) and a front bearing (5) which are axially spaced between said rotor and said casing, each of said bearings having an internal member (4i, 5i) mounted on the rotor (1) and an external member (4e, 5e) secured to the casing (3), said rotor having a torque transmission mechanism (6) which is arranged at the front of the front bearing (5), said system being characterized in that the members (51, 5e) of the front bearing (5) each have two runway tracks (12i, 13i; 12e, 13e) which are axially spaced so as to form two raceways between said members, in which is respectively arranged a row of spherical rolling bodies (14) to enable rotation of the internal member (5i) relative to the external member (5e) about the axis (A) of the rotor (1), the rows of rolling bodies (14) being in angular contact in the raceways in an X arrangement.

2. Transmission system according to claim 1, characterized in that the external member (5e) of the front bearing (5) is formed in one piece, on which the two runway tracks (12e, 13e) are formed.

3. Transmission system according to claim 2, characterized in that the two runway tracks (12e, 13e) are connected by a central zone (15) formed on the piece.

4. Transmission system according to claim 1, characterized in that the internal member (51) of the front bearing (5) is formed in one piece on which the two runway tracks (12i, 13i) are formed.

5. Transmission system according to claim 4, characterized in that the two runway tracks (12i, 13i) are separated by a collar (16) formed as a radial projection on the piece.

6. Transmission system according to claim 1, characterized in that the members (4i, 4e) of the rear bearing (4) each have a runway track (17i, 17e) forming between said members a raceway in which a row of rolling bodies (18) is arranged to enable rotation of the internal member (4i) relative to the external member (4e) about the axis (A) of the rotor (1), said rolling bodies being spherical and mounted in radial contact in the raceway.

7. Transmission system according to claim 1, characterized in that the rotor (1) has a front bearing surface (7a) onto which the front internal member (5i) is radially shrunk via a complementary bearing surface (9a).

8. Transmission system according to claim 7, characterized in that the complementary bearing surface (9a) has a central recess (19) forming on either side a shrunk-on section on the front bearing surface (7a) of the rotor (1).

9. Transmission system according to claim 1, characterized in that the casing (3) has a front bearing surface (3b) onto which the front external member (5e) is radially shrunk via a complementary bearing surface (23).

10. Transmission system according to claim 9, characterized in that the front bearing surface (3b) is bordered by a front groove (24) in which a ring (25) is arranged, said ring being in axial interference with the front external member (5e) to retain it axially on the front bearing surface (3b).

11. Transmission system according to claim 1, characterized in that the front external member (5e) has a flange (21) extending radially outwards from said member, said flange being associated with the casing (3) by having a rear face (21a) which bears axially against a front wall (3a) of the casing (3), said flange and said casing being equipped with means for clamping said face to said wall.

12. Transmission system according to claim 11, characterized in that the flange (21) has a peripheral bearing surface (21b) which is radially shrunk onto a complementary bearing surface (3c) of the casing (3).

13. Transmission system according to claim 11, characterized in that the flange (21) delimits a rear complementary bearing surface (23a) on the front external member (5e), said bearing surface being shrunk radially into a front bearing surface (3b) of the casing (3).

14. Transmission system according to claim 1, characterized in that the front bearing (5) is equipped with at least one sealing device comprising an element (20) which is fixed to the external member (5e) for rubbing against the internal member (5i) and/or the rotor (1).

15. Transmission system according to claim 1, characterized in that the torque transmission mechanism (6) comprises at least one gear (6a) which is mounted around the rotor (1) at the front of the front bearing (5), in particular a helical gear.
